(19) United States
(12) Patent Application Publication
(10) Pub. No.: US 2013/0037196 A1
(43) Pub. Date: Feb. 14, 2013

(54) PNEUMATIC RADIAL TIRE

(71) Applicant: Norihiko KODAMA, Osaka-shi (JP)

(72) Inventor: Norihiko KODAMA, Osaka-shi (JP)

(73) Assignee: TOYO TIRE & RUBBER CO., LTD., Osaka (JP)

(21) Appl. No.: 13/565,151

(22) Filed: Aug. 2, 2012

(30) Foreign Application Priority Data
Aug. 8, 2011 (JP) 2011-173057

(51) Int. Cl. B60C 15/06

(52) U.S. Cl. 152/541

(57) ABSTRACT

A pneumatic radial tire has a carcass ply wound up around a bead core, a chafer wound up around the bead core to be arranged in an outer side of the carcass ply, and a side wall rubber. A reinforcing rubber is provided between a rubber filler and the side wall rubber to pinch a wind-up end of the carcass ply and a wind-up end of the chafer. The reinforcing rubber has a monolithic layer extending in a tire diametrical direction. An upper end of the monolithic layer is positioned at a height which is 0.9 to 1.1 times a height of a tire maximum width position based on a rim reference line. A lower end of the monolithic layer is positioned in an outer side of the chafer at a height within ±10 mm based on the rim reference line.

### BACKGROUND OF THE INVENTION

1. Field of the Invention

The present invention relates to a pneumatic radial tire which is characterized by a structure of a bead portion and has a high durability. The present invention is particularly useful for a pneumatic radial tire for a heavy load.

2. Description of the Related Art

Conventionally, in a pneumatic radial tire which is particularly used in a vehicle having a heavy weight, such as an industrial vehicle or a construction vehicle, there has been fear that a trouble such as separation is caused from a wound-up end of a carcass ply wound up around a bead core. Accordingly, it is generally carried out to intend an improvement of a durability of the bead portion by arranging a reinforcing member called a chafer along the carcass ply, as disclosed in Patent Documents 1 and 2. However, even if the chafer is arranged, durability may deteriorate due to a protruding deformation of a bead portion, and there is a room for further improving this.

FIG. 8 is a view describing a protruding deformation of a bead portion. In the tire at the time of traveling, a side wall portion greatly bends under an application of an internal pressure and a load, and as shown in FIG. 8, a bead portion 1 protrudes to an outer side along a rim flange 91 so as to be deformed. If the protruding deformation mentioned above is repeated in connection with a rolling motion of the tire, a great strain acts on a wind-up end 4E of a carcass ply and a wind-up end 6E of a chafer which topple toward an outer side, and a trouble beginning at them tends to be generated.

### PRIOR ART DOCUMENTS

Patent Document 1: Japanese Unexamined Patent Publication No. 2002-331810
Patent Document 2: Japanese Unexamined Patent Publication No. H05-319035

### SUMMARY OF THE INVENTION

The present invention has been made in view of the above circumstances, and an object of the present invention is to provide a pneumatic radial tire that suppresses a protruding deformation of a bead portion at the time of traveling, and has excellent durability.

The object can be achieved by the following present invention. That is, the present invention provides a pneumatic radial tire comprising a bead core which is buried in a bead portion, a rubber filler which is arranged in an outer side in a tire diametrical direction of the bead core, a carcass ply which is wound up around the bead core from an inner side to an outer side, a chafer which is wound up around the bead core so as to be arranged in an outer side of the carcass ply, and a side wall rubber which forms an outer wall surface of the tire, wherein a reinforcing rubber is provided between the rubber filler and the side wall rubber in such a manner as to pinch a wind-up end of the carcass ply and a wind-up end of the chafer, and wherein the reinforcing rubber has a monolithic layer which extends in a tire diametrical direction, an upper end of the monolithic layer is positioned at a height which is 0.9 to 1.1 times a height of a tire maximum width position based on a rim reference line, and a lower end of the monolithic layer is positioned in an outer side of the chafer at a height within ±10 mm based on the rim reference line.

In the tire according to the present invention, the reinforcing rubber provided between the rubber filler and the side wall rubber has the monolithic layer in which the upper end and the lower end are positioned at the height mentioned above, and the monolithic layer which is longer in the tire diametrical direction serves as a support post which suppresses the protruding deformation of the bead portion, at the time of traveling. In addition, since the upper end of the monolithic layer is in the vicinity of the tire maximum width position, the rigidity of the portion having the greatest bend is improved, and since the lower end of the monolithic layer is in the vicinity of the bead heel, it is possible to reduce the toppling of the reinforcing rubber by appropriately applying the fitting pressure with the rim, and it is further possible to effectively suppress the protruding deformation. As a result, it is possible to suppress the occurrence of the trouble beginning at the wind-up ends of the carcass ply and the chafer, making it possible to improve durability.

The monolithic layer is a rubber layer which is made of an integrally formed single layer, and has a monolithic shape in a tire meridian cross section. Further, the lower end of the monolithic layer being positioned at the height within ±10 mm based on the rim reference line means the lower end of the monolithic layer being positioned between a height of 10 mm to an outer side in a tire diametrical direction from the rim reference line, and a height of 10 mm to an inner side in the tire diametrical direction from the rim reference line. The rim reference line is a tire axial direction line which passes through a rim diameter defined by a standard of JATMA.

In the pneumatic radial tire in accordance with the present invention, it is preferable that a predetermined elongation tensile stress S100 of the reinforcing rubber is between 1.6 MPa and 6.2 MPa. Since the reinforcing rubber is made of the rubber having a high tensile stress, it is possible to effectively suppress the protruding deformation of the bead portion, and it is possible to suppress the occurrence of the trouble beginning at the wind-up ends of the carcass ply and the chafer. In the present invention, the predetermined elongation tensile stress S100 (which may be, hereinafter, called as “S100”) conforms to JISK6251, and is a tensile stress under 100% elongation, which is measured by a tensile tester by using a test piece of a dumbbell third under a condition of an ambient temperature of 23° C.

In the pneumatic radial tire in accordance with the present invention, it is preferable that the reinforcing rubber has a high tensile stress layer which has a predetermined elongation tensile stress S100 greater than the monolithic layer and protrudes to the inner side in the tire width direction from the side surface of the monolithic layer, and the wind-up end of the carcass ply and the wind-up end of the chafer are pinched by the high tensile stress layer.

According to the structure mentioned above, since the wind-up ends of the carcass ply and the chafer which tend to be a starting point at which the trouble occurs are pinched by the high tensile stress layer having the high tensile stress, an effect of improving durability is enhanced. Further, since the high tensile stress layer protrudes to an inner side in the tire width direction from the side surface of the monolithic layer, it is possible to increase a volume of the high tensile stress layer so as to effectively enhance the effect of improving the durability.

In the above structure, it is preferable that the predetermined elongation tensile stress S100 of the monolithic layer is between 1.6 MPa and 5.6 MPa, and the predetermined elongation tensile stress S100 of the high tensile stress layer is between 2.2 MPa and 6.2 MPa and is greater than the predetermined elongation tensile stress S100 of the monolithic layer by 0.6 MPa or more. According to this structure, it is possible to set the tensile stress of the high tensile stress layer high so as to effectively enhance the effect of improving the durability.

In the pneumatic radial tire in accordance with the present invention, it is preferable that the upper end of the high tensile stress layer is positioned at a height which is 0.2 to 0.65 times the height of the tire maximum width position based on the rim reference line. According to this structure, it is possible to enhance the effect of improving the durability by appropriately arranging the high tensile stress layer at the height which tends to generate the protruding deformation of the bead portion.

### BRIEF DESCRIPTION OF THE DRAWINGS

FIG. 1 is a half cross sectional view of a tire meridian showing an example of a pneumatic radial tire in accordance with the present invention;

FIG. 2 is a cross sectional view showing a bead portion of the tire in FIG. 1 in an enlarged manner;

FIG. 3 is a cross sectional view showing a bead portion according to another embodiment of the present invention;

FIG. 4 is a cross sectional view showing a bead portion according to another embodiment of the present invention;

FIG. 5 is a cross sectional view showing a bead portion according to another embodiment of the present invention;

FIG. 6 is a cross sectional view showing a bead portion according to a comparative example;

FIG. 7 is a cross sectional view showing a bead portion according to a comparative example; and

FIG. 8 is a view describing a protruding deformation of a bead portion.

### DETAILED DESCRIPTION OF THE PREFERRED EMBODIMENTS

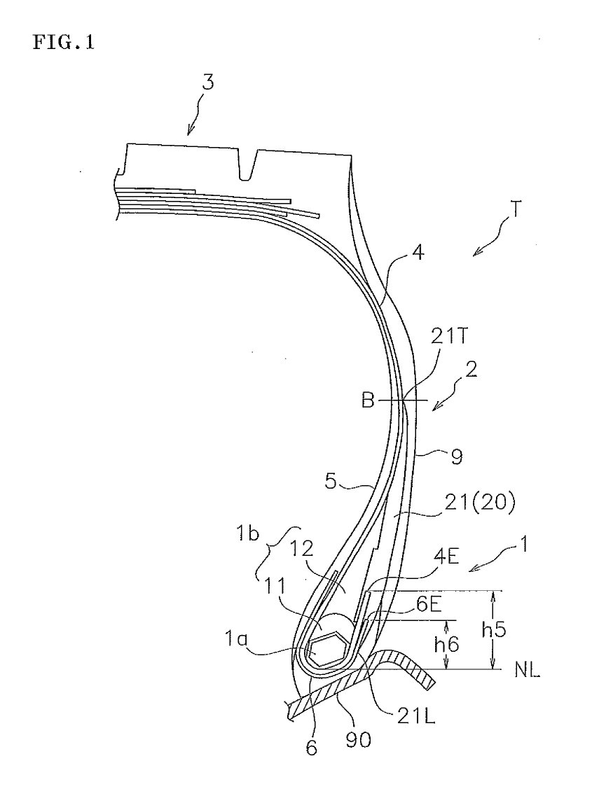

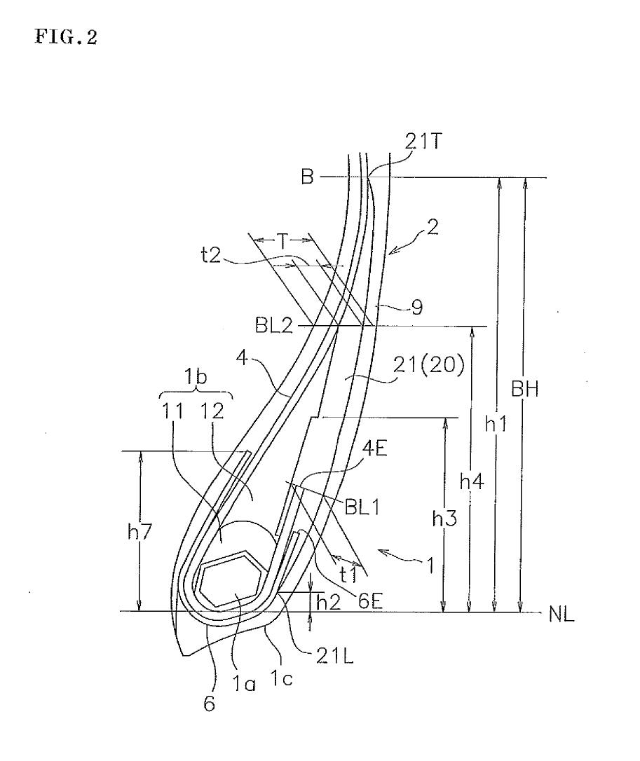

An embodiment of the present invention will be explained with reference to the drawings. A tire T shown in FIG. 1 is one example of a pneumatic radial tire according to the present invention, and there is shown a tire meridian cross section at a specified rim installing time. The specified rim installing time indicates a state where a tire is mounted on a rim specified by JATMA depending on its size, and a maximum pneumatic pressure corresponding to a single wheel maximum load capacity specified by JATMA is applied to the tire in the same manner. FIG. 2 is a cross sectional view showing a bead portion 1 of the tire T in an enlarged manner.

The tire T comprises a pair of bead portions 1, sidewall portions 2 which extend to an outer side in a tire diametrical direction from the bead portions 1, and a tread portion 3 which is connected to outer ends in the tire diametrical direction of the sidewall portions 2 so as to form a tread surface. An annular bead core 1a is buried in the bead portion 1. The bead core 1a is constructed by a converged body obtained by laminating and winding a rubber coated bead wire. A rubber filler 1b is arranged in the bead portion 1. The rubber filler 1b is positioned in an outer side of the tire diametrical direction of the bead core 1a.

A carcass ply 4 extends between the bead cores 1a which are arranged in a pair of bead portions 1, and is wound up to an outer side from an inner side around the bead core 1a. A wound-up portion of the carcass ply 4 is arranged in an outer side in a tire width direction of the bead core 1a or the rubber filler 1b, and a leading end thereof comes to a wound-up end 4E. The carcass ply 4 is formed by coating a ply cord arranged in a direction which is approximately orthogonal to a tire circumferential direction, with a topping rubber. A steel cord or an organic fiber cord is preferably used as the ply cord.

An inner side of the carcass ply 4 is provided with an inner liner rubber 5 which constructs an inner surface of the tire T. The inner liner rubber 5 has a function of inhibiting a transmission of a gas which is filled in the tire. Further, in the sidewall portion 2, a sidewall rubber 9 constructing an outer wall surface of the tire T is provided in an outer side of the carcass ply 4.

A chafer 6 is wound up around the bead core 1a so as to be arranged in an outer side of the carcass ply 4. The chafer 6 according to the present embodiment is wound up to the outer side from the inner side in such a manner as to wrap the carcass ply 4, but not limited thereto, may be wound up from a position in an inner side in the tire diametrical direction of the bead core 1a. The chafer 6 is constructed by a steel chafer including steel cords (one example of a metal cord). The steel cords are arranged diagonally (for example, an angle of incline between 20 and 50 degrees) with respect to the tire circumferential direction, and are coated with a topping rubber.

The rubber filler 1b includes a lower filler 11 which surrounds the bead core 1a and is formed into a round cross sectional shape, and an upper filler 12 which is arranged in an outer side in the tire diametrical direction of the lower filler 11 and has a lower rubber hardness than the lower filler. An upper surface of the lower filler 11 is formed by a curved surface which is convex to an outer side in the tire diametrical direction. The upper filler 12 has such a shape as to be tapered toward the outer side in the tire diametrical direction, and a leading end thereof is arranged in the outer side in the tire diametrical direction than the wound-up end 4E of the carcass ply 4 and a wind-up end 6E of the chafer 6.

A reinforcing rubber 20 is provided between the rubber filler 1b and the side wall rubber 9 in such a manner as to pinch the wind-up end 4E of the carcass ply 4 and the wind-up end 6E of the chafer 6. The reinforcing rubber 20 has a monolithic layer 21 which extends in a tire diametrical direction, and pinches the wind-up end 4E and the wind-up end 6E by the monolithic layer 21. The present invention may be structured, as mentioned later, such that the reinforcing rubber has a high tensile stress layer in addition to the monolithic layer, and the wind-up ends 4E and 6E are pinched by the high tensile stress layer.

The monolithic layer 21 has an elongated shape in the tire diametrical direction, and in order to improve durability, the predetermined elongation tensile stress S100 (S100) is preferably between 1.6 MPa and 6.2 MPa. An upper end 21T as a leading end in an outer side in the tire diametrical direction of the monolithic layer 21 is set to an outer side in the tire diametrical direction than an upper end of the rubber filler 1b, and is arranged in the vicinity of a tire maximum width position B. Further, a lower end 21L as a leading end in an inner side in the tire diametrical direction of the monolithic layer 21 is set to an inner side in the tire diametrical direction than an upper end of the bead core 1a, and is arranged in the vicinity of a bead heel 1c.

The upper end 21T is positioned at a height which is 0.9 to 1.1 times a height BH of the tire maximum width position B based on a rim reference line NL. In other words, a height h1 of the upper end 21T satisfies a relationship of 0.9BH≦h1≦1.1BH. On the assumption of 0.9BH>h1, it is impossible to effectively suppress the bend of the side wall portion 2, and the effect of suppressing the protruding deformation of the bead portion 1 tends to be smaller. Further, on the assumption of h1>1.1BH, the rigidity of the side wall portion 2 becomes too high, and a shock absorption (a ride comfort) tends to be deteriorated. In the illustrated example, the height h1 is set to be equal to the height BH.

The lower end 21L is positioned in an outer side of the chafer 6 at a height within ±10 mm based on the rim reference line NL. In other words, the height h2 of the lower end 21L is between 0 mm and 10 mm as long as the lower end 21L is in the outer side in the tire diametrical direction than the rim reference line NL, and is between −10 mm and 0 mm as long as the lower end 21L is in the inner side in the tire diametrical direction than the rim reference line NL. If the height h2 goes beyond 10 mm, the fitting pressure with the rim 90 can not be sufficiently obtained, and the effect of suppressing the protruding deformation of the bead portion 1 tends to be smaller. Further, the structure in which the height h2 goes below −10 mm is not practical since it causes deterioration of uniformity.

The monolithic layer 21 which is longer in the tire diametrical direction functions as a support post which suppresses the protruding deformation of the bead portion 1, at the time of traveling. In addition, since the upper end 21T is in the vicinity of the tire maximum width position B, the rigidity of the portion having the greatest bend of the side wall portion 2 is improved, and since the lower end 21L is in the vicinity of the bead heel 1c, it is possible to reduce the toppling of the reinforcing rubber 20 by appropriately applying the fitting pressure with the rim 90, and it is further possible to effectively suppress the protruding deformation of the bead portion 1. As a result, it is possible to suppress the occurrence of the trouble beginning at the wind-up end 4E and the wind-up end 6E, making it possible to improve durability of the bead portion 1.

The reinforcing rubber 20 is provided in such a manner as to cover the wind-up end 4E and the wind-up end 6E while coming into contact with the outer side in the tire width direction of the rubber filler 1b. More specifically, the reinforcing rubber 20 extends to the inner side in the tire diametrical direction than the wind-up end 4E so as to come into contact with the inner side and the outer side of the wind-up portion of the carcass ply 4, and further extends to the inner side in the tire diametrical direction than the wind-up end 6E so as to come into contact with the inner side and the outer side of the wind-up portion of the chafer 6. The reinforcing rubber 20 is interposed between the wind-up portion of the carcass ply 4 and the wind-up portion of the chafer 6.

Further, the reinforcing rubber 20 has a level difference which protrudes to the inner side in the tire width direction, at a position which is the outer side in the tire diametrical direction than the wind-up end 4E, and increases a thickness of a portion at which the protruding deformation tends to become greater. In the light of an enhancement of the effect of improving the durability of the bead portion 1, it is preferable that a height h3 of the level difference of the reinforcing rubber 20 based on the rim reference line NL satisfies a relationship of 0.2BH≦h3≦0.65BH, and it is more preferably that it satisfies a relationship of 0.3BH≦h3≦0.6BH.

A height h4 of the rubber filler 1b is set, for example, between 0.4BH and 0.85BH, and preferably set between 0.5BH and 0.7BH. A height h5 of the wind-up end 4E which is positioned in the outer side in the tire diametrical direction than the lower filler 11 is set, for example, between 0.2BH and 0.5BH, and a height h6 of the wind-up end 6E is set, for example, between 0.1BH and 0.35BH. In the present invention, even if the wind-up ends are arranged at the height mentioned above, it is possible to achieve excellent durability by suppressing the protruding deformation. The heights h4 to h6 are respectively heights which are based on the rim reference line NL.

Based on the rim reference line NL, a height h7 of a leading end (a curled end) which is positioned in the inner side in the tire width direction of the chafer 6 is set, for example, between 0.2BH and 0.7BH. In the case that the height h7 satisfies a relationship of h7>h5, it is possible to improve the rigidity of the bead portion 1 so as to effectively enhance the durability.

Assuming a reference line BL1 which is a normal line perpendicular to the outer surface of the tire, and passing through the wind-up end 4E of the carcass ply 4, it is preferable that a thickness t1 of the reinforcing rubber 20 on the reference line BL1 is equal to or more than 5.0 mm, whereby it is possible to effectively suppress the occurrence of the trouble caused by the protruding deformation. Further, it is preferable that the thickness t1 is equal to or less than 9.0 mm, whereby it is possible to sufficiently secure a thickness of the reinforcing rubber 20 in the side portion of the wind-up end 4E so as to effectively prevent an increase of the strain acting on the wind-up end 4E.

Assuming a reference line BL2 extending in the tire width direction while passing through the upper end of the rubber filler 1b, it is preferable that a thickness t2 of the monolithic layer 21 on the reference line BL2, and a total thickness T on the reference line BL2 satisfy a relationship of 0.3T≦t2≦0.5T. By satisfying the relationship of 0.3T≦t2, it is possible to secure the thickness of the monolithic layer 21 so as to effectively suppress the protruding deformation. Further, by satisfying the relationship of t2≦0.5T, the rigidity of the side wall portion 2 does not become too high, and the deterioration of the shock absorption (the ride comfort) is not caused.

The present invention may be structured such that an edge tape is attached as a U-shaped form to the wind-up end 4E and the wind-up end 6E, thereby suppressing the occurrence of the trouble beginning at them, particularly the occurrence and the progress of the separation. The edge tape is formed by a rubber material which has the same composition as the rubber pinching the wind-up ends 4E and 6E, however, may be formed by a rubber material having a different composition, and may be formed by an organic fiber such as nylon or the like. The edge tape has a thickness, for example, between 0.4 and 1.0 mm.

In order to suppress the protruding deformation of the bead portion 1, it is preferable that the reinforcing rubber 20 is made of a hard rubber having a rubber hardness (which indicates hardness measured at 23° C. in conformity to a durometer hardness test (typeA) of JISK6253, the same applies hereinafter) between 65° and 75°. Further, for example, the rubber hardness of the lower filler 11 is between 85° and 95°, and the rubber hardness of the upper filler 12 is between 56° and 66°.

It is preferable that tan δ at 80° C. of the upper filler 12 is within the range between 0.02 and 1.00. Accordingly, it is possible to suppress a heat generation of the bead portion 1 under traveling so as to enhance the effect of improving the durability. In the present embodiment, there is shown an example in which the rubber filler 1b is made of two kinds of rubbers of the lower filler 11 and the upper filler 12, however, it may be made of one kind of rubber (see FIG. 5), and in this case, it is preferable to use a hard rubber having S100 between 1.6 Mpa and 5.6 MPa for enhancing the rigidity of the bead portion 1.

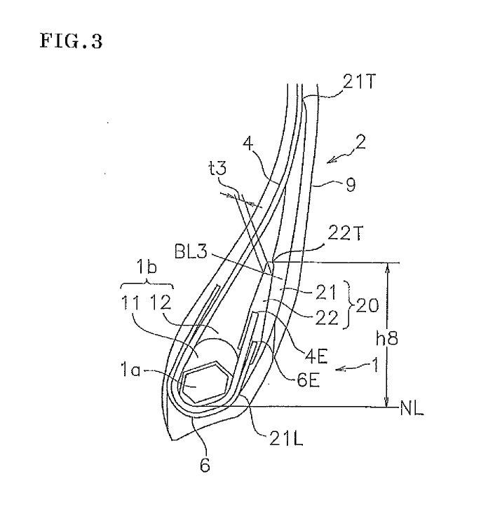

FIG. 3 is a cross sectional view showing a bead portion 1 according to another embodiment of the present invention. With the exception of the structure described below, since the structure and the operation are the same as those of the embodiment explained in FIGS. 1 and 2, a description will be given mainly of different points. The common points will not be repeated. The same reference numerals are attached to the same members and positions as the already described members and positions in the description mentioned above, and an overlapping description will be omitted.

In the example of FIG. 3, the reinforcing rubber 20 has a high tensile stress layer 22 which has a greater S100 than the monolithic layer 21 and protrudes to the inner side in the tire width direction from the side surface of the monolithic layer 21, and pinches the wind-up end 4E and the wind-up end 6E by the high tensile stress layer 22. According to this structure, it is possible to effectively suppress the occurrence of the trouble beginning at the wind-up ends 4E and 6E, so as to effectively enhance the effect of improving the durability.

In the reinforcing rubber 20 mentioned above, it is preferable that S100 of the monolithic layer 21 is between 1.6 MPa and 5.6 MPa, and S100 of the high tensile stress layer 22 is between 2.2 MPa and 6.2 MPa and is greater than S100 of the monolithic layer 21 by 0.6 MPa or more. According to this structure, it is possible to set S100 of the high tensile stress layer 22 high so as to effectively enhance the effect of improving the durability.

The reinforcing rubber 20 is provided in such a manner as to cover the wind-up end 4E and the wind-up end 6E while coming into contact with the outer side in the tire width direction of the rubber filler 1b. Since the high tensile stress layer 22 having the high tensile stress comes into contact with the wind-up portion of the carcass ply 4 and the wind-up portion of the chafer 6, it is possible to effectively suppress the occurrence of the trouble beginning at the wind-up ends 4E and 6E. The high tensile stress layer 22 is formed into an approximately triangular shape in its cross section, and an upper end 22T thereof forms the level difference of the reinforcing rubber 20. In the light of an enhancement of the effect of improving the durability, it is preferable that a height h8 of the upper end 22T based on the rim reference line NL satisfies a relationship of 0.2BH≦h8≦0.65BH, and it is more preferably that it satisfies a relationship of 0.3BH≦h8≦0.6BH.

Assuming a reference line BL3 which is a parallel straight line to the reference line BL1 and is away from the upper end 22T by 5 mm, it is preferable that a thickness t3 of the high tensile stress layer 22 on the reference line BL3 is equal to or more than 2.0 mm, whereby it is possible to enhance the effect of suppressing the protruding deformation of the bead portion 1. Further, the thickness t3 is preferably equal to or less than 4.0 mm, whereby it is easy to secure the thickness of the monolithic layer 21 and this is convenient.

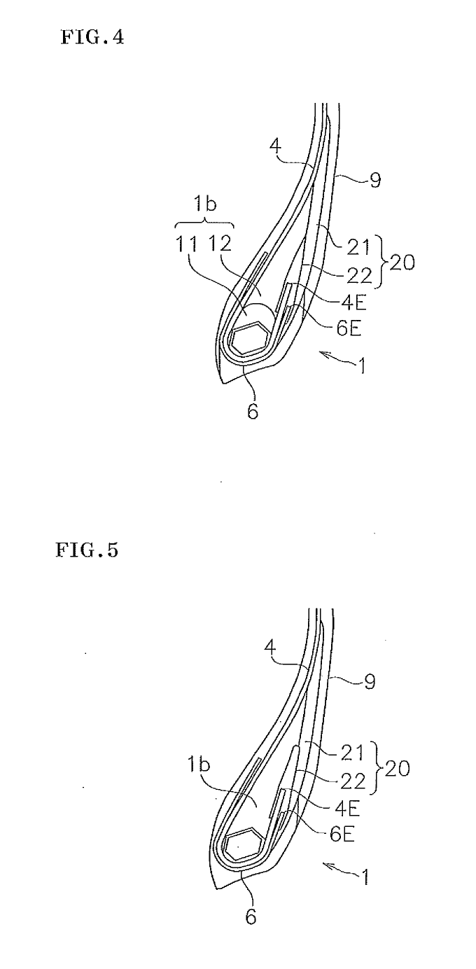

FIGS. 4 and 5 are cross sectional views each showing a bead portion 1 according to the other embodiments of the present invention. FIG. 4 is an example in which the leading end in the outer side in the tire diametrical direction of the high tensile stress layer 22 is sharp. In this regard, in order to increase the thickness of the high tensile stress layer at the portion of which the protruding deformation tends to become large, the high tensile stress layer having the shape as shown in FIG. 3 is preferable. FIG. 5 is an example in which the rubber filler 1b is made of one kind of rubber, and the present invention may be provided with the rubber filler mentioned above.

The pneumatic radial tire in accordance with the present invention is the same as the normal pneumatic tire except the structure as mentioned above of the bead portion, and the present invention can employ any of the conventionally known material, shape, structure, manufacturing method and the like.

Since the pneumatic radial tire according to the present invention is excellent in a durability of the bead portion, it is useful for a pneumatic radial tire for a heavy load which is used in a vehicle having a heavy vehicle weight such as a truck, a bus, an industrial vehicle, or a construction vehicle.

### Example

Since a durability test of the bead portion was carried out in order to specifically show the structure and the effect of the present invention, a description will be given below. A tire used for the test had a size of 11R22.5, and was installed to a rim having a size specified by JATMA.

In the durability test, under a condition of an internal pressure 900 kPa and a speed 40 km/h, the tire was traveled on a drum, a load was gradually increased from 230% in the JATMA normal condition, and a traveling distance at the time when the trouble occurred was evaluated. Accordingly, the longer traveling distance indicates excellent durability.

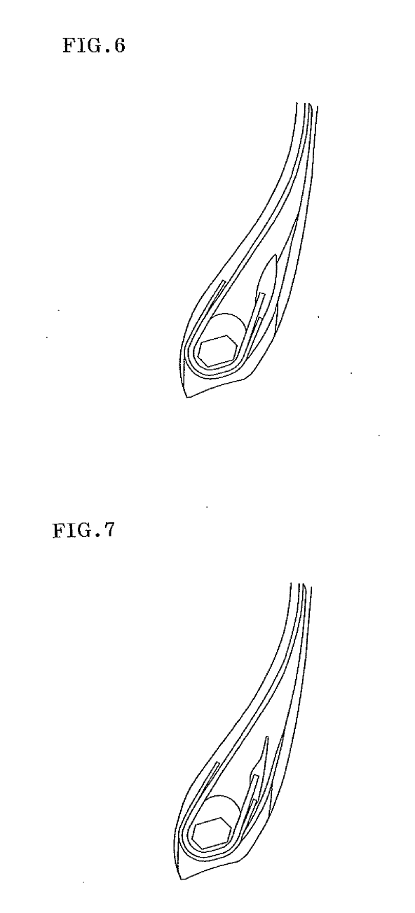

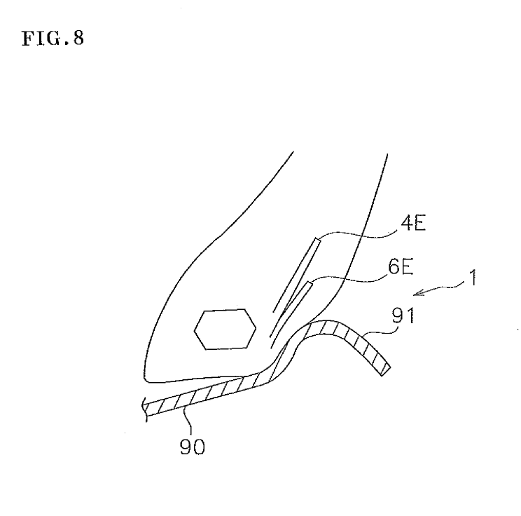

The bead structure and the result of evaluation in comparative examples 1 to 3 and working examples 1 to 4 are as shown in Table 1. The bead structures of the comparative examples 1 and 2 are respectively shown in FIGS. 6 and 7, and the reinforcing rubber is formed by the rubber material having the same composition as the upper filler in the comparative example 2. The bead structures of the comparative example 3 and the working examples 2 and 3 are respectively shown in FIG. 3, however, the height of the upper end of the monolithic layer is different. In each of the examples, the height h2 is 5.0 mm in each of them, and the tire structure and the rubber composition except the bead structure are in common.

TABLE 1

| | | S100 (MPa) | | | | Height | Height | Height | Traveling |
|---|---|---|---|---|---|---|---|---|---|
| | | Monolithic | High tensile | Height h1 | | h5 | h6 | h7 | distance |
| | Shape | layer | stress layer | (mm) | Rate | (mm) | (mm) | (mm) | (km) |
| Comparative | FIG. 6 | 3.5 | 4.0 | 85 | 0.7BH | 40 | 20 | 45 | 12000 |
| example 1 | | | | | | | | | |
| Comparative | FIG. 7 | 2.5 | 4.0 | 120 | 1.0BH | 40 | 20 | 45 | 12000 |
| example 2 | | | | | | | | | |
| Comparative | FIG. 3 | 2.5 | 4.0 | 95 | 0.8BH | 40 | 20 | 45 | 11000 |
| example 3 | | | | | | | | | |
| Working | FIG. 2 | 2.5 | — | 120 | 1.0BH | 40 | 20 | 45 | 14000 |
| Example 1 | | | | | | | | | |
| Working | FIG. 3 | 3.5 | 4.0 | 110 | 0.9BH | 40 | 20 | 45 | 13000 |
| Example 2 | | | | | | | | | |
| Working | FIG. 3 | 2.5 | 4.0 | 120 | 1.0BH | 40 | 20 | 45 | 16000 |
| Example 3 | | | | | | | | | |
| Working | FIG. 3 | 3.5 | 4.0 | 120 | 1.0BH | 40 | 20 | 55 | 21000 |
| Example 4 | | | | | | | | | |

As shown in Table 1, the traveling distance is longer in all the working examples 1 to 4 than the comparative examples 1 to 3, and the durability is improved. Further, in the working example 3, the durability is improved more than the working example 1 in spite that the height of the upper end of the monolithic layer is the same as the working example 1, and the effect obtained by arranging the high tensile stress layer appears. On the other hand, since the height of the monolithic layer comes short, it is thought that the comparative examples 1 and 3 cannot sufficiently suppress the protruding deformation.

What is claimed is:

1. A pneumatic radial tire comprising:
a bead core which is buried in a bead portion;
a rubber filler which is arranged in an outer side in a tire diametrical direction of the bead core;
a carcass ply which is wound up around the bead core from an inner side to an outer side;
a chafer which is wound up around the bead core so as to be arranged in an outer side of the carcass ply; and
a side wall rubber which forms an outer wall surface of the tire,
wherein a reinforcing rubber is provided between the rubber filler and the side wall rubber in such a manner as to pinch a wind-up end of the carcass ply and a wind-up end of the chafer, and
wherein the reinforcing rubber has a monolithic layer which extends in a tire diametrical direction, an upper end of the monolithic layer is positioned at a height which is 0.9 to 1.1 times a height of a tire maximum width position based on a rim reference line, and a lower end of the monolithic layer is positioned in an outer side of the chafer at a height within ±10 mm based on the rim reference line.

2. The pneumatic radial tire according to claim 1, wherein a predetermined elongation tensile stress S100 of the reinforcing rubber is between 1.6 MPa and 6.2 MPa.

3. The pneumatic radial tire according to claim 1, wherein the reinforcing rubber has a high tensile stress layer which has a predetermined elongation tensile stress S100 greater than the monolithic layer and protrudes to the inner side in the tire width direction from the side surface of the monolithic layer, and the wind-up end of the carcass ply and the wind-up end of the chafer are pinched by the high tensile stress layer.

4. The pneumatic radial tire according to claim 3, wherein the predetermined elongation tensile stress S100 of the monolithic layer is between 1.6 MPa and 5.6 MPa, and the predetermined elongation tensile stress S100 of the high tensile stress layer is between 2.2 MPa and 6.2 MPa and is greater than the predetermined elongation tensile stress S100 of the monolithic layer by 0.6 MPa or more.

5. The pneumatic radial tire according to claim 3, wherein the upper end of the high tensile stress layer is positioned at a height which is 0.2 to 0.65 times the height of the tire maximum width position based on the rim reference line.
